(19) United States
(12) Patent Application Publication
(10) Pub. No.: US 2005/0056730 A1
(43) Pub. Date: Mar. 17, 2005

(54) Automatic pilot apparatus

(76) Inventors: Takashi Nagayama, Tokyo (JP); Hiroshi Yoneda, Tokyo (JP)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 10/870,319

(22) Filed: Jun. 17, 2004

(30) Foreign Application Priority Data
Jun. 19, 2003 (JP) 2003-175088

(51) Int. Cl. G05D 1/00

(52) U.S. Cl. 244/175

(57) ABSTRACT

Refurbishment work on installation of an automatic pilot apparatus into an aircraft is significantly simplified. An automatic pilot apparatus 1 which is installable in an aircraft comprises: a navigation device 2 to guide the aircraft along a predetermined flight path; actuators 3a to 3d to drive control surfaces of the aircraft; a flight computer 4 to control the actuators 3a to 3d; a case body 10 to contain the navigation device 2, the actuators 3a to 3d, and the flight computer 4; a fixing member to fix the case body 10 to a pilot seat S of the aircraft; and additional rods 30a to 30d to transmit driving forces of the actuators 3a to 3d to the control surfaces.

### BACKGROUND OF THE INVENTION

1. Field of the Invention

The present invention relates to an automatic pilot apparatus, and particularly relates to an automatic pilot apparatus which is installable in an aircraft.

2. Description of the Related Art

There has been proposed an automatic pilot apparatus which performs automatic drive control of a control surface of an aircraft or a parachute, and realizes a flight (parachuting) along a predetermined path (for example, see Patent Document 1: page 1, FIG. 1 of JP-Tokukaihei-5-319397A). Generally, such an automatic pilot apparatus is designed so as to be installed inside the airframe of an unfinished aircraft or the like.

In contrast, regarding a manned aircraft without an automatic pilot apparatus installed, a plurality of components such as a gyro, a flight computer, and servo motors are distributedly mounted inside the airframe, and these components are electrically connected to each other, thus constituting an automatic pilot apparatus, as shown in FIG. 10 (for example, see Non-patent Document 1: “Shin Koku Kogaku Koza, Thirteenth Volume, Koku Denshi Sobi, Second Volume,” by Shoei Kato, Japan Aeronautical Engineers' Association, Apr. 17, 1992).

However, as described above, to install an automatic pilot apparatus in an existing aircraft, significantly major and complicated refurbishment work is required. For example, work of detaching a control panel of the pilot seat, disposing a gyro and a flight computer therein, and connecting them with each other, work of detaching an access panel in a rear portion of the fuselage, removing control cables, and mounting servo motors which drive respective control surfaces, work of connecting the flight computer in the control panel with the servo motors in the rear portion of the fuselage, and the like are required. Therefore, extremely lots of time and labor have been expended for the refurbishment work.

### SUMMARY OF THE INVENTION

An object of the present invention is to significantly simplify the refurbishment work on installation of an automatic pilot apparatus in an aircraft.

In order to solve the above problem, an automatic pilot apparatus according to a first aspect of the present invention is an automatic pilot apparatus which is installable in an aircraft, comprising: a navigation device to guide the aircraft along a predetermined flight path; a driving member to drive a control surface of the aircraft; a control device to control the driving member; a case body to contain the navigation device, the driving member, and the control device; a fixing member to fix the case body to a predetermined place in the aircraft; and a driving force transmission member to transmit a driving force of the driving member to the control surface.

According to such an automatic pilot apparatus, components through which an automatic piloting is realized (navigation device, driving member, and control device) are contained in the case body. A system capable of automatic piloting can be constituted, without requiring major refurbishment work, by fixing the case body to the predetermined place in an aircraft using the fixing member, and transmitting a driving force of the driving member in the case body to the control surface of the aircraft using the driving force transmission member.

Preferably, the automatic pilot apparatus comprises a driving force blocking member to prevent a driving force of the driving member from being transmitted to the control surface.

According to such an automatic pilot apparatus, the driving force blocking member to prevent a driving force of the driving member from being transmitted to the control surface is included; therefore, for example, when an inappropriate driving force is generated due to failure in the driving member or the control device, the inappropriate driving force can be prevented from being transmitted to the control surface. As a result, a safe flight operation can be realized.

The automatic pilot apparatus may comprise an operation member to perform an operation related to start and stop of an automatic piloting operation.

According to such an automatic pilot apparatus, the operation member to perform an operation related to start and stop of an automatic piloting operation is included; therefore, the pilot of an aircraft can arbitrarily decide the timing of starting or stopping an automatic piloting operation. In other words, switching from manual piloting to automatic piloting, or switching from automatic piloting to manual piloting can be freely performed.

Moreover, the automatic pilot apparatus may comprise a display device to display a state of an automatic piloting operation.

According to such an automatic pilot apparatus, the display device to display a state of an automatic piloting operation is included; therefore, the pilot of an aircraft can monitor a state of an automatic piloting operation, and can recognize whether the automatic pilot apparatus is functioning without fail, whether the aircraft is flying along a predetermined flight path by automatic piloting, and the like.

### BRIEF DESCRIPTION OF THE DRAWINGS

FIG. 1 is a block diagram for explaining the functional configuration of an automatic pilot apparatus according to a first embodiment of the present invention;

FIG. 2 is a perspective view showing a state where the automatic pilot apparatus shown in FIG. 1 is attached on a pilot seat of an existing aircraft;

FIG. 3 is a partial transparent view for explaining the internal configuration of the automatic pilot apparatus shown in FIG. 2;

FIG. 4 is a top view of the automatic pilot apparatus shown in FIG. 3;

FIG. 5 is a perspective view showing the external view and the internal configuration of an automatic pilot apparatus according to a second embodiment of the present invention;

FIG. 6 is a perspective view showing a state where the automatic pilot apparatus shown in FIG. 5 is attached on a pilot seat of an existing aircraft;

FIG. 7 is a partial transparent view for explaining the internal configuration of the automatic pilot apparatus shown in FIG. 5;

FIG. 8 is a partial transparent view showing the positional relationship among additional rods of the automatic pilot apparatus shown in FIG. 5;

FIGS. 9A, 9B, 9C and 9D are explanatory views each showing a state of connection between the respective additional rods of the automatic pilot apparatus shown in FIG. 5 and respective control surfaces; and

FIG. 10 is an explanatory view for explaining an automatic pilot apparatus based on earlier development which is installed in an existing aircraft after manufactured.

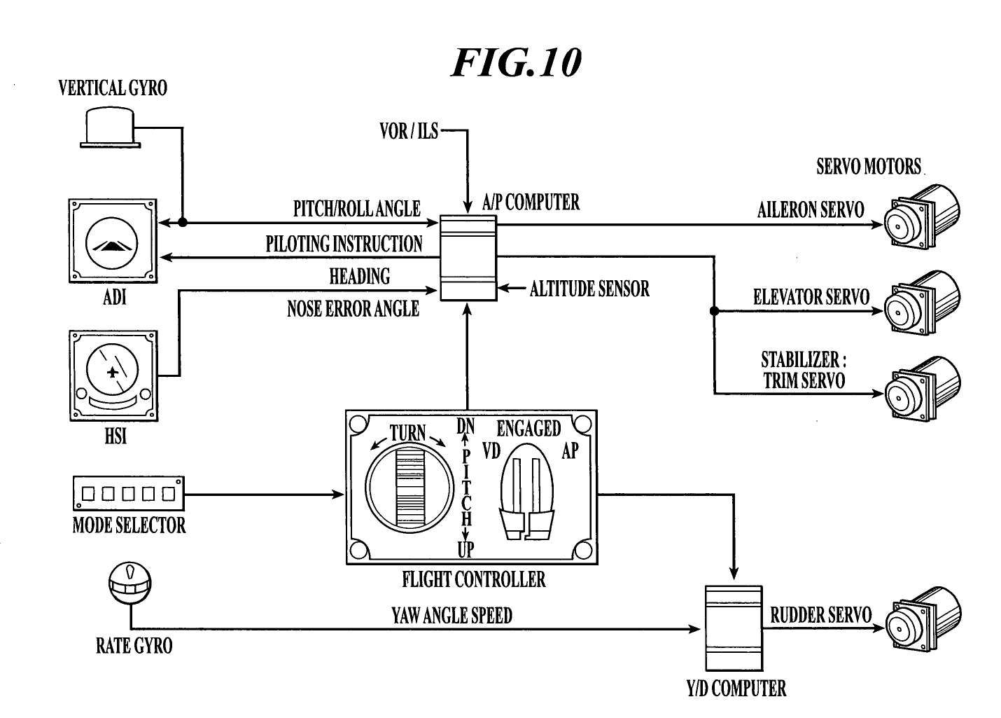

### DETAILED DESCRIPTION OF THE PREFERRED EMBODIMENTS

### First Embodiment

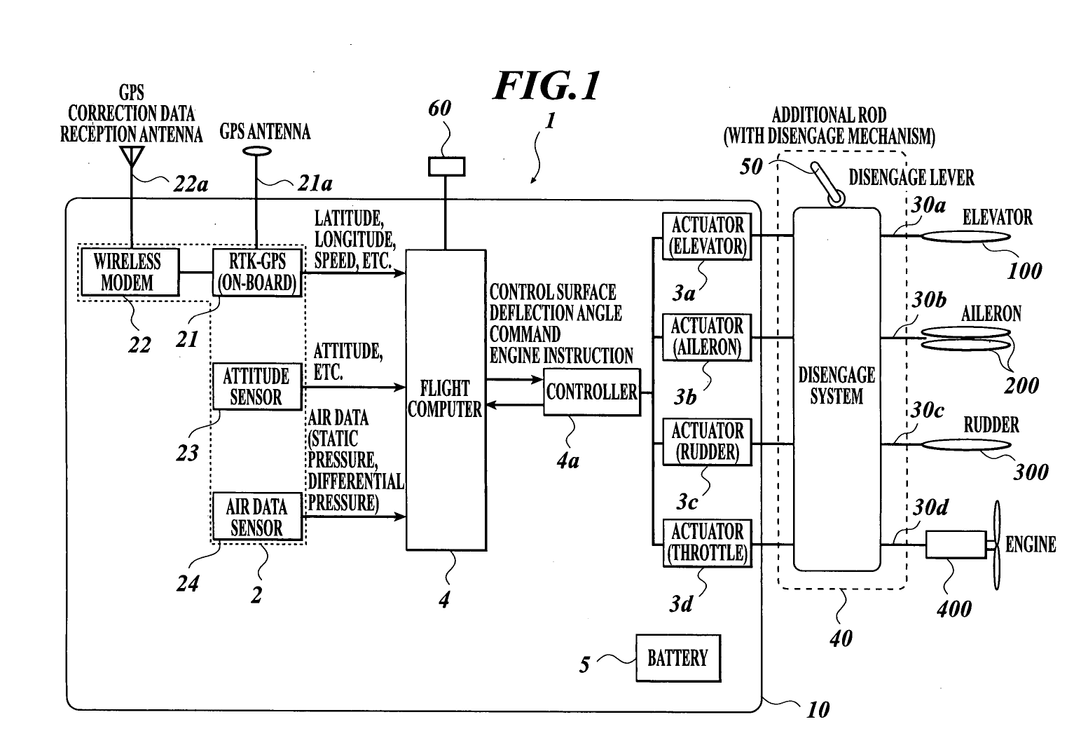

First, the configuration of an automatic pilot apparatus 1 according to a first embodiment of the present invention will be described using FIGS. 1 to 4. The automatic pilot apparatus 1 according to this embodiment is mounted on a pilot seat S of a fixed wing manned aircraft to construct a system which enables automatic piloting.

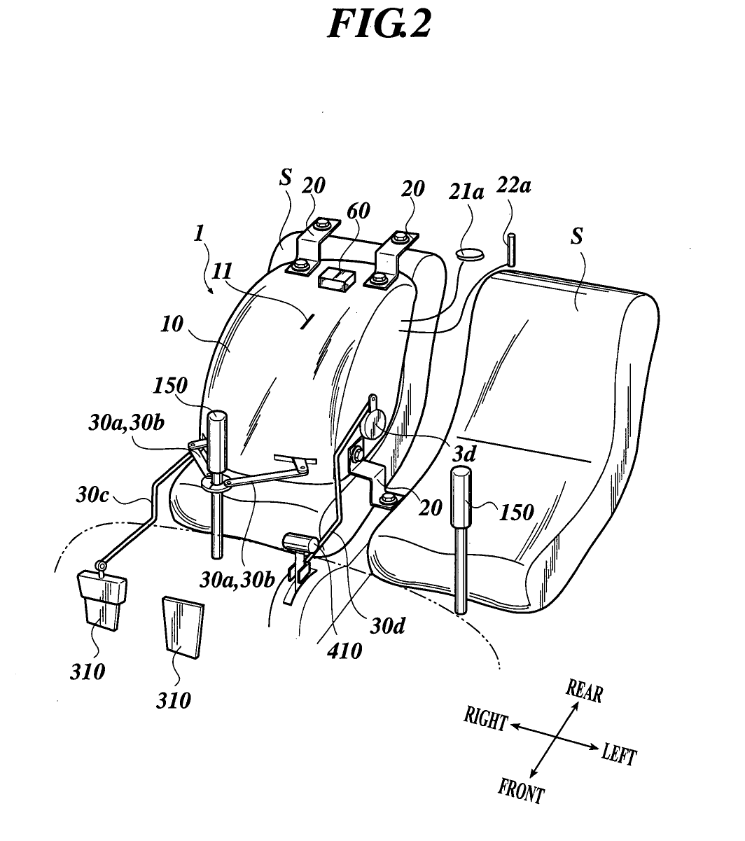

As shown in FIG. 1, the automatic pilot apparatus 1 includes: a navigation device 2 to guide an aircraft along a predetermined flight path; actuators 3a to 3d to drive control surfaces and the like of the aircraft; a flight computer 4 to control the actuators 3a to 3d; a battery 5 to supply electric power to the navigation device 2 and the flight computer 4; and the like. The navigation device 2, actuators 3a to 3d, flight computer 4, battery 5, and the like are contained in a case body 10, as shown in FIGS. 2 to 4.

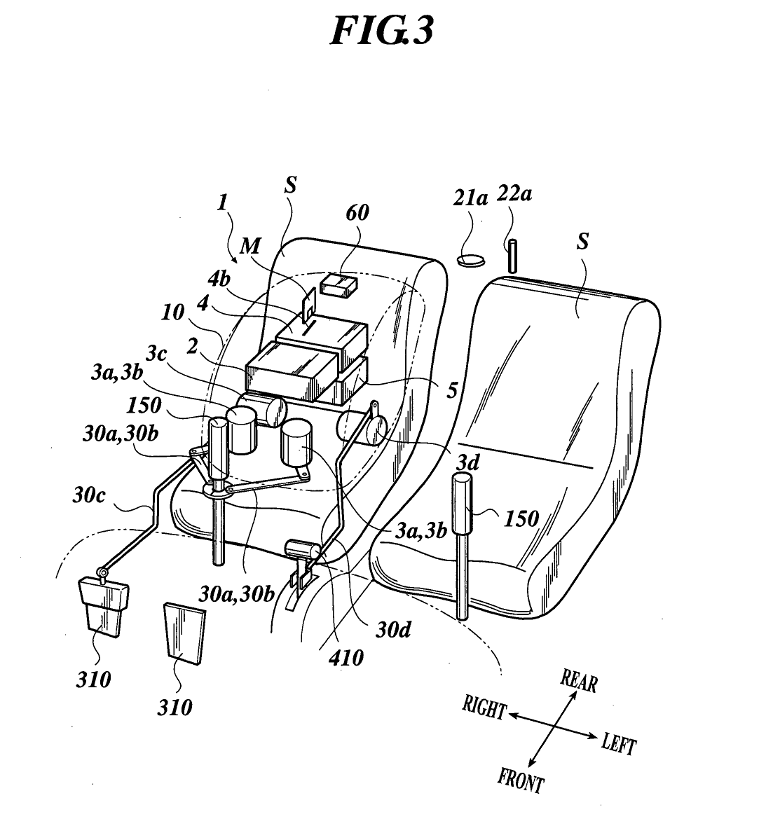

The navigation device 2 includes: an RTK-GPS 21 to receive a signal from a predetermined GPS satellite through a GPS antenna 21a to obtain location (latitude, longitude) information and speed information on the aircraft; a wireless modem 22 to obtain highly accurate location information through a GPS correction data reception antenna 22a; an attitude sensor 23 to detect an attitude (roll angle, pitch angle, yaw angle, etc.) of the aircraft; an air data sensor 24 to detect such as a static pressure and an outside air temperature; and the like (see FIG. 1). Moreover, the navigation device 2 has a case in a substantially rectangular solid shape as shown in FIG. 3, and the aforementioned RTK-GPS 21, wireless modem 22, attitude sensor 23, air data sensor 24, and the like are contained inside this case.

The actuators 3a to 3d are driving members in the present invention, which drive control surfaces (elevator 100, ailerons 200, and rudder 300) of the aircraft and control an output of an engine 400. The respective actuators 3a to 3d are connected to the respective control surfaces and the like through such as additional rods 30a to 30d which are driving force transmission members in the present invention (see FIGS. 1 to 4).

More specifically, the actuator 3a is connected to the elevator 100 through the additional rod 30a and a control stick 150, and drives the elevator 100 upon reception of a control surface deflection angle command from the flight computer 4. The actuator 3b is connected to the ailerons 200 through the additional rod 30b and the control stick 150, and drives the ailerons 200 upon reception of a control surface deflection angle command from the flight computer 4.

In this embodiment, the combination of the actuator 3a and the actuator 3b constitutes a control stick driving actuator. Portions of the control stick driving actuator is contained in right and left cylindrical cases (see FIGS. 2 to 4). Further, the additional rod 30a and the additional rod 30b are integrated to constitute a control stick driving rod. This control stick driving rod couples the right and left control stick driving actuator portions to the control stick 150 (see FIGS. 2 to 4). The control stick driving actuator, namely, the actuators 3a and 3b, moves the control stick 150 to the front, rear, right and left through the control stick driving rods 30a and 30b, whereby the elevator 100 and the ailerons 200 can be driven.

Moreover, the actuator 3c is connected to the rudder 300 through the additional rod 30c and rudder pedals 310, and drives the rudder 300 upon reception of a control surface deflection angle command from the flight computer 4. The actuator 3c is contained in a cylindrical case (see FIGS. 2 to 4).

Moreover, the actuator 3d is connected to an engine 400 through the additional rod 30d and a throttle lever 410, and controls an output of the engine 400 upon reception of an engine instruction from the flight computer 4. The actuator 3d is contained in a cylindrical case (see FIGS. 2 to 4).

The flight computer 4 is a control device in the present invention, which is electrically connected to the navigation device 2 and the actuators 3a to 3d (see FIG. 1). The flight computer 4 includes: a ROM (Read Only Memory) in which automatic piloting control programs are stored; a CPU (Control Processing Unit) to execute the control programs; and the like. The flight computer 4 outputs a control instruction (control surface deflection angle command, engine instruction) for controlling the actuators 3a to 3d, based on information on such as the location, attitude, speed, and altitude of the aircraft inputted from the navigation device 2.

The control instruction outputted from the flight computer 4 is transmitted to the actuators 3a to 3d through a controller 4a (see FIG. 1). Signals related to operations of the actuators 3a to 3d are fed back to the flight computer 4 through the controller 4a to be used for control (see FIG. 1).

Further, the flight computer 4 has a case in a substantially rectangular solid shape as shown in FIG. 3, and the ROM, CPU, and the like are contained inside this case. Moreover, the flight computer 4 is provided with a slot portion 4b into which a recording medium M is inserted (see FIG. 3). The recording medium M on which various kinds of data (flight plan data, airframe aerodynamics data), control programs, and the like, which are necessary for an automatic piloting, are recorded is inserted into the slot portion 4b, and the data and programs are read to be used for control of an automatic piloting.

The case body 10 has a three-dimensional shape including curved surfaces along the bottom portion and the seat back of the pilot seat S (see FIG. 2), and is fixed to the pilot seat S through fixing members 20 such as fittings and bolts. In this embodiment, the seatbelt is detached from the seatbelt fixing fittings, and the case body 10 is fixed to these fittings through bolts and nuts. Moreover, the case body 10 is provided with a slit 11 through which the recording medium M is inserted inside thereof (see FIG. 2).

Further, the automatic pilot apparatus 1 includes a disengage system 40 to prevent driving forces of the respective actuators 3a to 3d from being transmitted to the respective control surfaces (elevator 100, ailerons 200, and rudder 300) and to the engine 400 (see FIG. 1). Furthermore, the automatic pilot apparatus 1 includes a disengage lever 50 to perform activation and stop of the disengage system 40 (see FIG. 1).

When the disengage lever 50 is operated in a state where an automatic piloting is on, the disengage system 40 is activated, and driving forces of the respective actuators 3a to 3d are not transmitted to the respective control surfaces and the engine 400. Consequently, the automatic piloting can be stopped. On the contrary, when the disengage lever 50 is returned to the original position, an automatic piloting can be started again. The disengage system 40 is a driving force blocking member in the present invention, and the disengage lever 50 is an operation member in the present invention.

When rotary motors are used as the actuators 3a to 3d as in the case of this embodiment, electromagnetic clutches may be disposed between the rotary portions of the rotary motors and the respective additional rods, thereby causing the electromagnetic clutches to function as the disengage system 40. Alternatively, a power supply switch to shut off electric power supplied to the actuators 3a to 3d can be employed as the disengage system 40. The electromagnetic clutches and the power supply switch may be used together.

Moreover, the automatic pilot apparatus 1 includes a display device 60 to display a state of an automatic piloting operation (see FIGS. 1 to 3). In this embodiment, it is assumed that on and off of an automatic piloting is displayed in order to notify the pilot of an aircraft, and that a way point number (number that indicates up to which number in the flight plan data the flight has been through) is displayed.

In the aircraft of this embodiment, another pilot seat S is provided next to the pilot seat S on which the automatic pilot apparatus 1 is mounted (see FIG. 2), and the pilot may take a seat on the former pilot seat S to perform manual piloting. Another control stick 150, which belongs to the former pilot seat S on which the pilot takes a seat, is provided with a switch (not shown) to perform activation and stop of the automatic pilot apparatus 1. The switch provided to this control stick 150 is an operation member in the present invention.

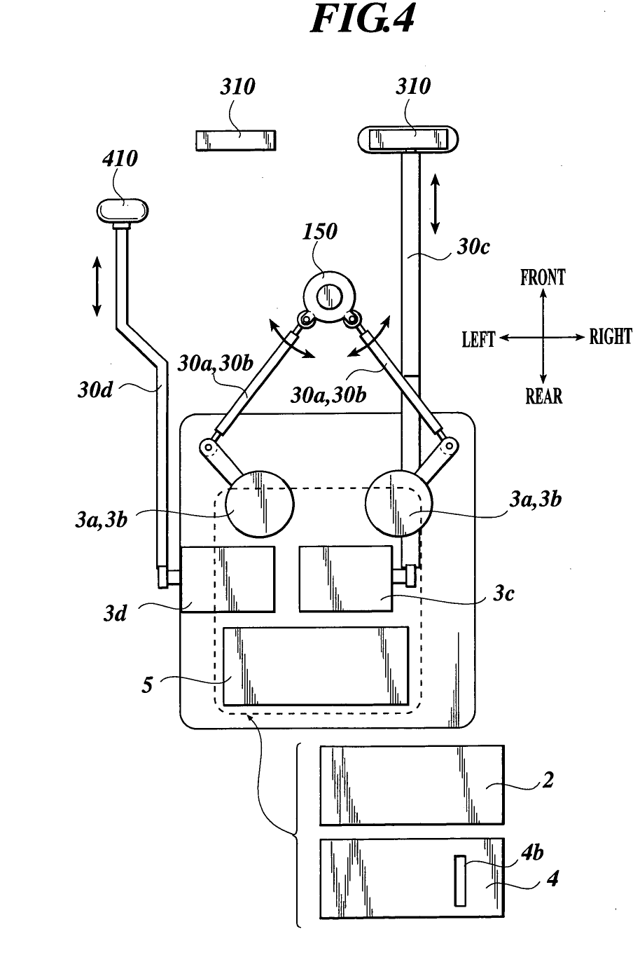

In the automatic pilot apparatus 1 according to this embodiment, components through which automatic piloting is realized (navigation device 2, actuators 3a to 3d, flight computer 4, and the like) are contained in the case body 10 (see FIGS. 1 and 3). A system capable of automatic piloting can be constituted, without requiring major refurbishment work, by fixing the case body 10 to the pilot seat S of an aircraft using the fixing members 20 (see FIG. 2), and transmitting driving forces of the actuators 3a to 3d in the case body 10 to the respective control surfaces and the like of the aircraft using the additional rods 30a to 30d (see FIG. 4).

Moreover, in the automatic pilot apparatus 1 according to this embodiment, the disengage system 40 to prevent driving forces of the actuators 3a to 3d from being transmitted to the respective control surfaces and the like is included; therefore, when an inappropriate driving force is generated due to failure in any one of the actuators 3a to 3d and the flight computer 4, the inappropriate driving force can be prevented from being transmitted to the control surface(s) and the like. As a result, a safe flight operation can be realized.

Further, in the automatic pilot apparatus 1 according to this embodiment, the operation members (disengage lever 50 and switch on control stick 150) to perform an operation related to start and stop of an automatic piloting operation are included; therefore, the pilot of an aircraft can arbitrarily decide the timing of starting or stopping an automatic piloting operation. In other words, switching from manual piloting to automatic piloting, or switching from automatic piloting to manual piloting can be freely performed.

Furthermore, in the automatic pilot apparatus 1 according to this embodiment, the display device 60 to display a state of an automatic piloting operation is included; therefore, the pilot of an aircraft can monitor a state of an automatic piloting operation, and can recognize whether the automatic pilot apparatus 1 is functioning without fail, whether the aircraft is flying along a predetermined flight path by automatic piloting, and the like.

### Second Embodiment

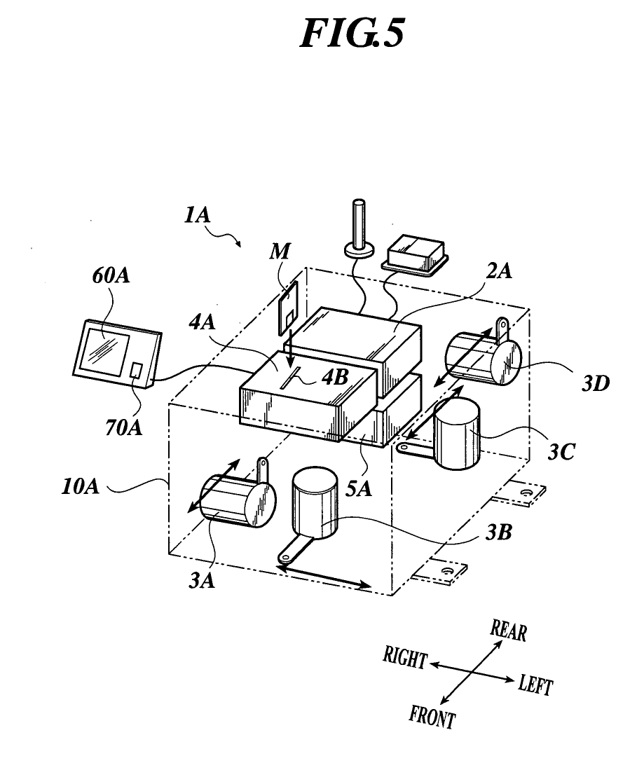

Next, the configuration of an automatic pilot apparatus 1A according to a second embodiment will be described using FIGS. 5 to 9D. Respective components of the automatic pilot apparatus 1A according to this embodiment have substantially the same functions as those of the respective components of the automatic pilot apparatus 1 according to the first embodiment, and thus a block diagram to show the functional configuration of the automatic pilot apparatus 1A will be substantially the same as the block diagram shown in the first embodiment. Hence, the block diagram is omitted, and only the mechanical configuration will be described.

As shown in FIGS. 5 to 8, the automatic pilot apparatus 1A includes: a navigation device 2A to guide an aircraft along a predetermined flight path; actuators 3A to 3D to drive control surfaces and the like of the aircraft; a flight computer 4A to control the actuators 3A to 3D; a battery 5A to supply electric power to the navigation device 2A and the flight computer 4A; and the like. The navigation device 2A, actuators 3A to 3D, flight computer 4A, battery 5A, and the like are contained in a case body 10A, as shown in FIGS. 5 to 8.

The configuration of the navigation device 2A is substantially the same as the configuration of the navigation device 2 in the first embodiment, and thus the description thereof will be omitted. Similarly, the configuration of the flight computer 4A is substantially the same as the configuration of the flight computer 4 in the first embodiment, and thus the description thereof will be omitted. The flight computer 4A is provided with a slot portion 4B into which a recording medium M is inserted (see FIG. 5).

Each of the actuators 3A to 3D, which are driving members, is contained in a cylindrical case (see FIG. 5), and connected to respective control surfaces (elevator 100, ailerons and rudder 300) and to an engine through such as additional rods 30A to 30D which are driving force transmission members.

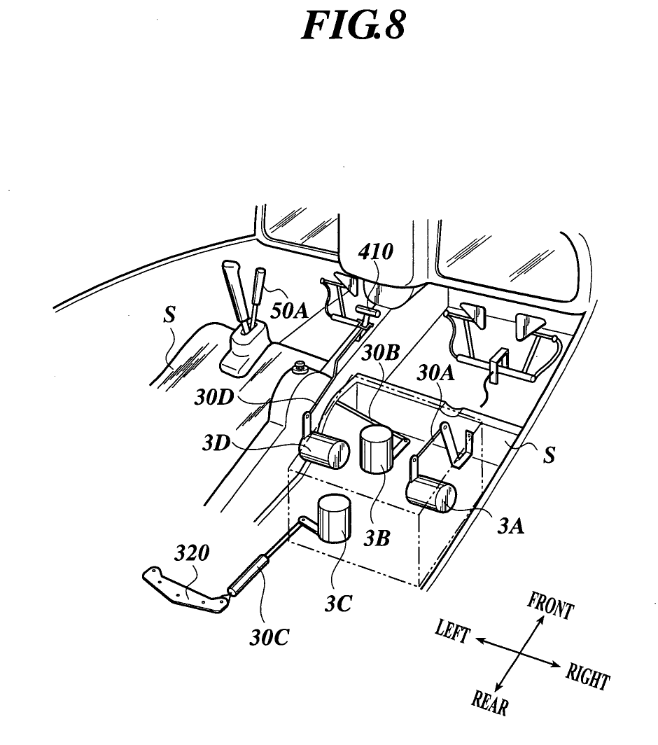

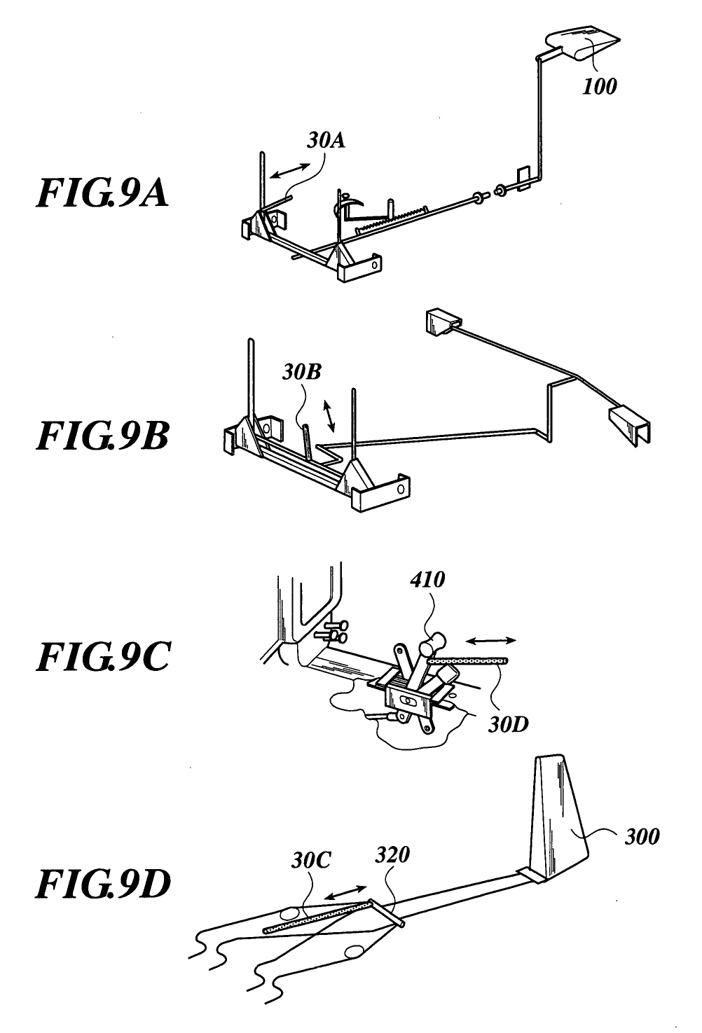

More specifically, the actuator 3A is connected to the elevator 100 through the additional rod 30A (see FIG. 8 and FIGS. 9A to 9D), and drives the elevator 100 upon reception of a control surface deflection angle command from the flight computer 4A. The actuator 3B is connected to the ailerons (not shown) through the additional rod 30B (see FIG. 8 and FIGS. 9A to 9D), and drives the ailerons upon reception of a control surface deflection angle command from the flight computer 4A.

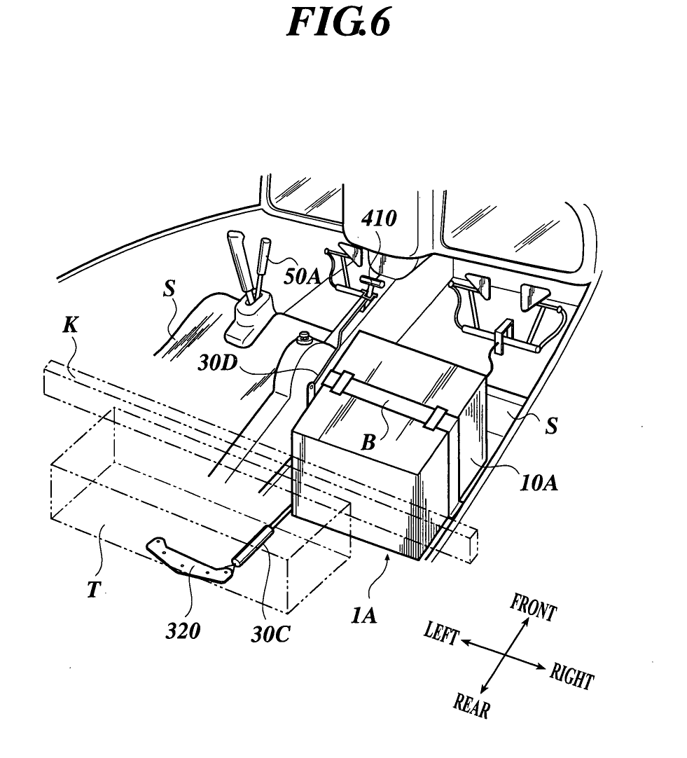

The actuator 3C is connected to the rudder 300 through the additional rod 30C and a rudder lever 320 (see FIG. 8 and FIGS. 9A to 9D), and drives the rudder 300 upon reception of a control surface deflection angle command from the flight computer 4A. In this embodiment, the additional rod 30C is allowed to pass through between a main wing spar structure K as well as a fuel tank T and an airframe skin (not shown) (see FIG. 6).

The actuator 3D is connected to an engine (not shown) through the additional rod 30D and a throttle lever 410 (see FIG. 8 and FIGS. 9A to 9D), and controls an output of the engine upon reception of an engine instruction from the flight computer 4A.

The case body 10A has a substantially rectangular solid shape (see FIG. 5), and is fixed to a pilot seat S through a seatbelt B provided to the pilot seat S in advance, as well as through fittings, bolts, and the like (see FIG. 6). The seatbelt B, fittings and bolts to fix the case body 10A to the pilot seat S are fixing members in the present invention.

Further, as in the case of the automatic pilot apparatus 1 according to the first embodiment, the automatic pilot apparatus 1A includes a disengage system (not shown) to prevent driving forces of the respective actuators 3A to 3D from being transmitted to the respective control surfaces and the engine. The disengage system is connected to a disengage lever 50A provided to the pilot seat S (see FIGS. 6 to 8).

Moreover, as in the case of the automatic pilot apparatus 1 according to the first embodiment, the automatic pilot apparatus 1A includes a display device 60A to display a state of an automatic piloting operation (see FIG. 5). In the vicinity of the display device 60A, a switch 70A to perform activation and stop of the automatic pilot apparatus 1A is provided. The switch 70A provided in the vicinity of the display device 60A is an operation member in the present invention.

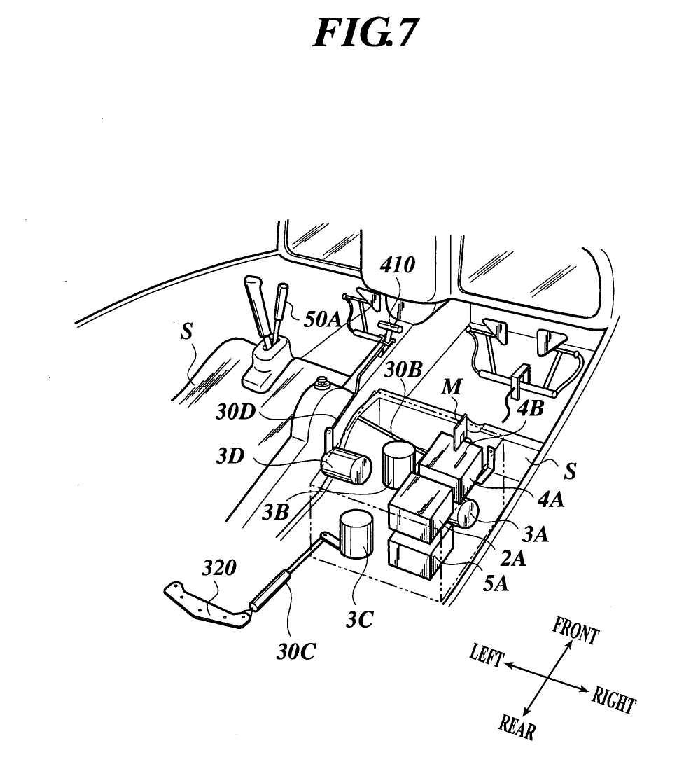

In the automatic pilot apparatus 1A according to this embodiment, components through which automatic piloting is realized (navigation device 2A, actuators 3A to 3D, flight computer 4A, and the like) are contained in the case body 10A (see FIGS. 5 and 7). A system capable of automatic piloting can be constituted, without requiring major refurbishment work, by fixing the case body 10A to the pilot seat S of an aircraft using the fixing members (see FIG. 6), and transmitting driving forces of the actuators 3A to 3D in the case body 10A to the respective control surfaces and the like of the aircraft using the additional rods 30A to 30D (see FIG. 8 and FIGS. 9A to 9D).

Moreover, in the automatic pilot apparatus 1A according to this embodiment, the disengage system to prevent driving forces of the actuators 3A to 3D from being transmitted to the respective control surfaces and the engine is included; therefore, when an inappropriate driving force is generated due to failure in any one of the actuators 3A to 3D and the flight computer 4A, the inappropriate driving force can be prevented from being transmitted to the control surface(s) and the like. As a result, a safe flight operation can be realized.

Further, in the automatic pilot apparatus 1A according to this embodiment, the operation members (disengage lever 50A and switch 70A) to perform an operation related to start and stop of an automatic piloting operation are included; therefore, the pilot of an aircraft can arbitrarily decide the timing of starting or stopping an automatic piloting operation. In other words, switching from manual piloting to automatic piloting, or switching from automatic piloting to manual piloting can be freely performed.

Furthermore, in the automatic pilot apparatus 1A according to this embodiment, the display device 60A to display a state of an automatic piloting operation is included; therefore, the pilot of an aircraft can monitor a state of an automatic piloting operation, and can recognize whether the automatic pilot apparatus 1A is functioning without fail, whether the aircraft is flying along a predetermined flight path by automatic piloting, and the like.

The automatic pilot apparatuses 1 and 1A according to the above embodiments are configured so as to perform drive control of the primary control surfaces (elevator, aileron, rudder) and the engine which are essential for a flight; however, by adding an actuator, the automatic pilot apparatuses 1 and 1A can be configured so as to perform drive control of a secondary control surface and the like (trim, flap, speed brake, wheel brake, etc.).

For example, by adding an actuator for a wheel brake, and transmitting a driving force of this actuator to the wheel brake using an additional rod, the ground run after landing can be automatically controlled. Moreover, by adding an actuator for a flap, and transmitting a driving force of this actuator to the flap using an additional rod, the flap can be automatically controlled.

According to the automatic pilot apparatus in accordance with a first aspect of the present invention, components through which automatic piloting is realized are contained in the case body. A system capable of automatic piloting can be constituted, without requiring major refurbishment work, by fixing the case body to a predetermined place using the fixing members, and transmitting driving forces of the driving members in the case body to the control surfaces of an aircraft using the driving force transmission members.

Moreover, by making it possible to prevent an inappropriate driving force attributable to failure in any one of the driving members and the control device from being transmitted to the control surface(s) by means of the driving force blocking member, a safe flight operation can be realized.

Further, with the operation members to perform an operation related to start and stop of an automatic piloting operation, the pilot of an aircraft can freely switch from manual piloting to automatic piloting, or from automatic piloting to manual piloting.

Furthermore, with the display device to display a state of an automatic piloting operation, the pilot of an aircraft can monitor whether the automatic pilot apparatus is functioning without fail, whether the aircraft is flying along a predetermined flight path by automatic piloting, and the like.

The entire disclosure of Japanese Patent Application No. 2003-175088 filed on Jun. 19, 2003 including specification, drawings and summary is incorporated herein by reference in its entirety.

1. An automatic pilot apparatus which is installable in an aircraft, comprising:
a navigation device to guide the aircraft along a predetermined flight path;
a driving member to drive a control surface of the aircraft;
a control device to control the driving member;
a case body to contain the navigation device, the driving member, and the control device;
a fixing member to fix the case body to a predetermined place in the aircraft; and
a driving force transmission member to transmit a driving force of the driving member to the control surface.

2. The automatic pilot apparatus as claimed in claim 1, further comprising a driving force blocking member to prevent a driving force of the driving member from being transmitted to the control surface.

3. The automatic pilot apparatus as claimed in claim 1, further comprising an operation member to perform an operation related to start and stop of an automatic piloting operation.

4. The automatic pilot apparatus as claimed in claim 2, further comprising an operation member to perform an operation related to start and stop of an automatic piloting operation.

5. The automatic pilot apparatus as claimed in claim 1, further comprising a display device to display a state of an automatic piloting operation.

6. The automatic pilot apparatus as claimed in claim 2, further comprising a display device to display a state of an automatic piloting operation.

7. The automatic pilot apparatus as claimed in claim 3, further comprising a display device to display a state of an automatic piloting operation.

8. The automatic pilot apparatus as claimed in claim 4, further comprising a display device to display a state of an automatic piloting operation.

9. An automatic pilot apparatus installable in an aircraft, comprising:
a control device to control the aircraft automatically along a predetermined flight path;
a case body including the control device; and
a fixing member to fix the case body to a predetermined place in the aircraft,
wherein said control device controlling the aircraft by driving a control surface of the aircraft by a driving force transmission member.
